(19) United States
(12) Patent Application Publication
(10) Pub. No.: US 2010/0189239 A1
(43) Pub. Date: Jul. 29, 2010

(54) ACCESSING DETAILS OF TELECONFERENCE CALL INVITEES

(76) Inventors: Steven M. Miller, Cary, NC (US); Lloyd W. Allen, JR., Cary, NC (US); Jana H. Jenkins, Raleigh, NC (US)

Correspondence Address: MOORE & VAN ALLEN, PLLC For IBM, P.O. Box 13706, Research Triangle Park, NC, 27709, US

(21) Appl. No.: 12/360,173

(22) Filed: Jan. 27, 2009

(51) Int. Cl. H04M 3/42

(52) U.S. Cl. 379/202.01

(57) ABSTRACT

Accessing information on call invitees that may include initiating a teleconference call, receiving an inquiry during the teleconference call regarding additional information on at least one person invited to join the call, obtaining the additional information on each of the at least one person, and sending the additional information. Also, a processing device may include a network interface, at least one second interface configured to establish a connection between at least three telephones, and a controller configured to initiate a teleconference call between the at least three telephones, receive an inquiry during the teleconference call regarding additional information on at least one person invited to join the call, obtain the additional information on each of the at least one person, and send the additional information.

### RELATED APPLICATIONS

The present application is related to the following applications that each have the same inventors and assignee and where the serial number is not yet known: “Contacting A Person Outside of a Teleconference Without Leaving the Teleconference”, Atty Docket 014682-000098; “Providing Multilevel Conference Call Participants”, Atty Docket 014682-000100; “Enhanced Announcement of Conference Call Participants”, Atty Docket 014682-000101; “Rules-Based Teleconferencing”, Atty Docket 014682-000103.

### BACKGROUND OF THE INVENTION

The present invention is related to teleconference calls, and more specifically to accessing details of teleconference call invitees.

Group meetings are a common and important element of many businesses. Teleconference calls are efficient in that they allow multiple people to have a meeting and not be physically located in the same room. Sometimes when an individual is getting ready for a teleconference call, they may like to be able to access data either right before joining the teleconference call or as they join the teleconference call. Information about who is already participating in the teleconference call may be helpful for deciding whether or not an individual invited to join the teleconference call needs to locate a key decision maker or subject matter expert. Further, if the individual is in the middle of doing something else, having knowledge regarding people that have not yet joined the teleconference call may allow the individual a little more time to finish up their current task. Moreover, an individual may be on a teleconference call with another person that they have not worked with before and may desire to look up additional information on the other person before the leader of the teleconference call begins the meeting. The individual may also desire to obtain other types of data or information before or during a teleconference call. Currently, the individual has no way of performing these tasks.

### BRIEF SUMMARY OF THE INVENTION

According to one aspect of the present invention, a method for accessing information on call invitees that includes initiating a teleconference call, receiving an inquiry during the teleconference call regarding additional information on at least one person invited to join the call, obtaining the additional information on each of the at least one person, and sending the additional information.

According to another aspect of the present invention, a processing device includes a network interface, at least one second interface, the at least one second interface configured to establish a connection between at least three telephones, and a controller, the controller being configured to initiate a teleconference call between the at least three telephones, receive an inquiry during the teleconference call regarding additional information on at least one person invited to join the call, obtain the additional information on each of the at least one person, and send the additional information.

According to a further aspect of the present invention, a computer program product comprising a computer useable medium having computer useable program code embodied therewith, the computer useable program code comprising computer useable program code configured to initiate a teleconference call, computer useable program code configured to receive an inquiry during the teleconference call regarding additional information on at least one person invited to join the call, computer useable program code configured to obtain the additional information on each of the at least one person, and computer useable program code configured to send the additional information.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a process for accessing information on call invitees according to an exemplary embodiment of the present invention;

FIG. 2 is a process for receiving an inquiry during a teleconference call according to an exemplary embodiment of the present invention;

FIG. 3 is a flowchart of a process for accessing information on call invitees according to another exemplary embodiment of the present invention; and

FIG. 4 is a diagram of a system for accessing information on call invitees according to an exemplary embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention allow an individual invited to a teleconference call to gather data regarding other invitees to the teleconference call before the individual either joins the teleconference call or after they have joined the teleconference call. Additional information about who is invited, who is currently on the teleconference call, who is not yet on the teleconference call, etc. may be requested and the information may be sent to the requester's desktop, telephone, etc. by a voice recording, text or visual data. This flexible information gathering may be highly beneficial in situations where individuals are constantly joining and leaving the teleconference call at different times. A chair of the teleconference call may access information about who has already joined the teleconference call, who has not yet joined the teleconference call and who has left the teleconference call without having to ask or poll individuals on the teleconference call, therefore making it easier to manage the added time constraints for the type of meeting that the chair desires to have.

According to embodiments of the present invention, a conference bridge may receive a request from an individual via a voice mail or text for data or information. Moreover, symbols on a keypad such as, for example, “*”, “#”, etc. may be used by a person that has joined a teleconference call while on the teleconference call to send a signal to a conference bridge of a specific command that the person wants to initiate. The command may be any of many types of commands, for example, for the conference bridge to send the individual information on one or more of invitees to the teleconference call, for the conference bridge to send the individual information on invites that have joined the teleconference call or that have not yet joined the teleconference call, for the conference bridge to send the individual information or data from a server, database, website, calendar system, etc. Symbols may also be used during a conference call (or before joining a conference call) to initiate other communications with a conference bridge.

Further, according to embodiments of the present invention, an invitee to a teleconference call, after the teleconference call has started, may decide to get additional information or data before deciding to join the teleconference call. A request may be sent by the individual to a conference bridge and the conference bridge may obtain the information and relay it back to the individual. The individual may then use this information to determine whether to join the teleconference call. For example, an individual may desire to get information regarding another person that has been invited to the teleconference call such as, for example, the persons position, title and organization, location, department of person, phone number of person, email of person, whether the person was invited to the teleconference, whether the person has joined the teleconference, etc. In addition, an individual may desire to obtain information that does not relate to another person such as, for example, reports, charts, statistics, news information, weather information, financial information, website information, information from a database, information from the Internet, information from a corporate internet, etc. This information may be requested and received by the individual before the individual joins a teleconference call or after the individual has joined the teleconference call. The conference bridge may access one or more databases, networks, meeting invitations, calendars of individuals, directories, the Internet, etc. to retrieve the requested information. The conference bridge may prompt the individual to provide additional data that may be needed to allow the conference bridge to retrieve the requested information (e.g., email address, URL to desired website, password, etc.).

In addition, according to embodiments of the present invention, a conference bridge may access a remote network, a database, a meeting invitation, a calendar of a person, a server, or a corporate directory for an unknown user so that the user can submit new, additional, or updated biographical information. Further, a conference bridge may update a remote network, a database, a meeting invitation, a calendar of a person, a server, or a corporate directory for an unknown user so that the user can submit new, additional, or updated biographical information.

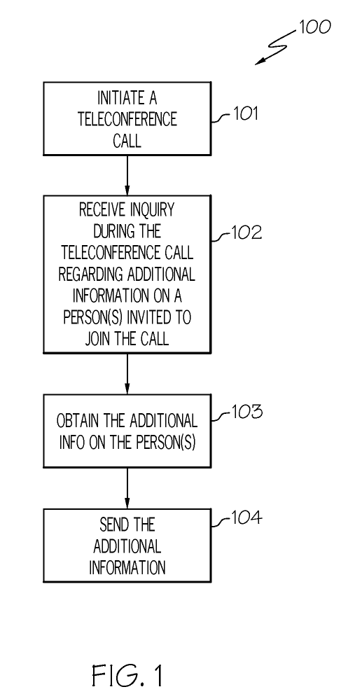

FIG. 1 shows a process for accessing information on call invitees according to an exemplary embodiment of the present invention. In the process 100, in block 101, a teleconference call may be initiated. In block 102, an inquiry may be received during the teleconference call regarding additional information on one or more persons invited to join the call. In block 103, the initial information may be obtained on the one or more persons. In block 104, the additional information may then be sent to the requester.

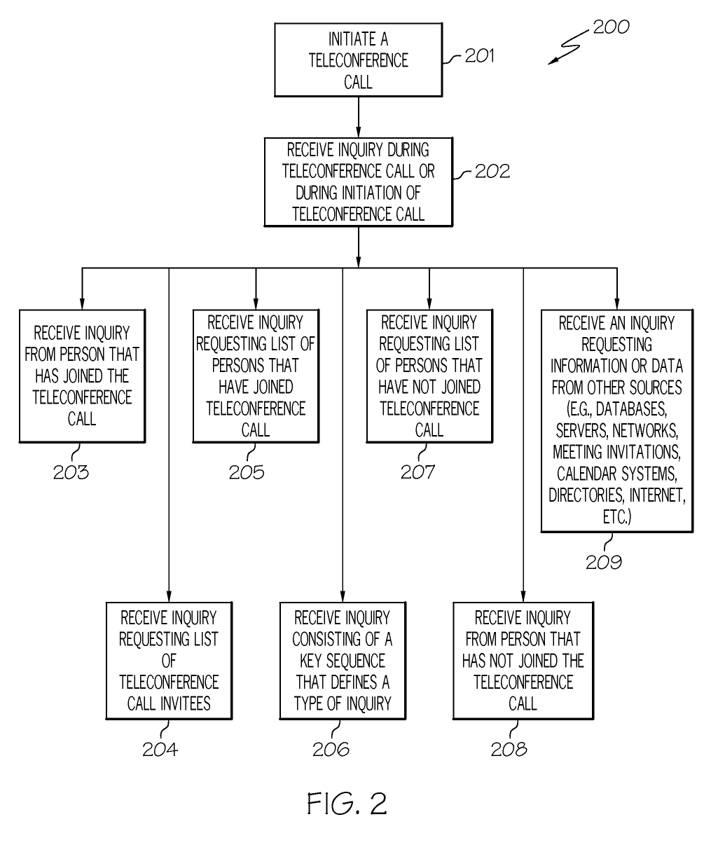

FIG. 2 shows a process for receiving an inquiry during a teleconference call according to an exemplary embodiment of the present invention. In the process 200, in block 201, a teleconference call may be initiated. In block 202, an inquiry may be received during the teleconference call or during initiation of the teleconference call. One or more types of inquiries may be received. For example, in block 203, an inquiry may be received from a person that has joined the teleconference call. In block 204, an inquiry requesting a list of conference call invitees may be received. In block 205, an inquiry may be received requesting a list of persons that have joined the teleconference call. In block 206, an inquiry may be received that consists of a key sequence that defines a type of inquiry. For example, a “*”, “#”, etc. may be used to define a particular command where associated data or parameters are also submitted as a part of the inquiry. In block 207, an inquiry may be received requesting a list of persons that have not joined the teleconference call. In block 208, an inquiry may be received from a person that has not joined the teleconference call. In block 209, an inquiry may be received requesting a information or data from one or more databases, servers, networks, meeting invitations, calendars of individuals, directories, or the Internet.

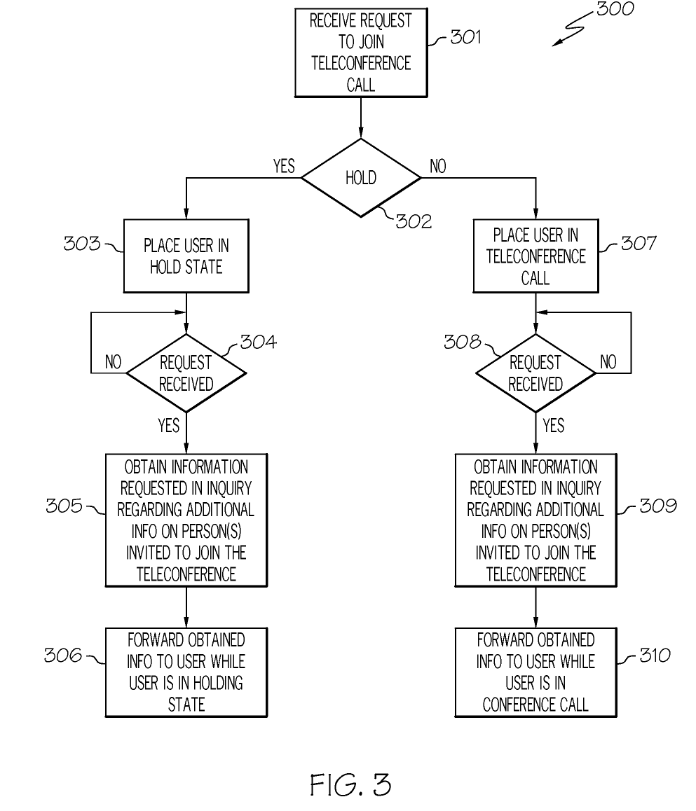

FIG. 3 shows a flowchart of a process for accessing information on call invitees according to another exemplary embodiment of the present invention. In the process 300, in block 301, a request may be received to join a teleconference call. In block 302, it may be determined whether to place the requester on hold. If it is determined to place the requester on hold before placing the requester in the teleconference call, in block 303, the requester/user may be placed in a hold state. Then in block 304, it may be determined if a request has been received regarding additional information on one or more persons invited to join the teleconference call and if so, then in block 305, the additional information requested may be obtained. In block 306, the obtained information may then be forwarded to the user while the user is in the holding state.

If it is determined not to place the user on hold, then in block 307, the user may be placed in the teleconference call. Then in block 308, it may be determined if a request for additional information regarding one or more persons invited to join the teleconference has been received and if so, then in block 309, the additional information may be obtained. In block 310, the obtained information may then be forwarded to the user while the user is in the teleconference call. Although this embodiment of the present invention has been discussed regarding information on persons invited to join the teleconference call, the information may not relate to invitees of the teleconference call but a user may request additional information that may be any type of data or other information obtainable from databases, other networks, servers, the Internet, etc.

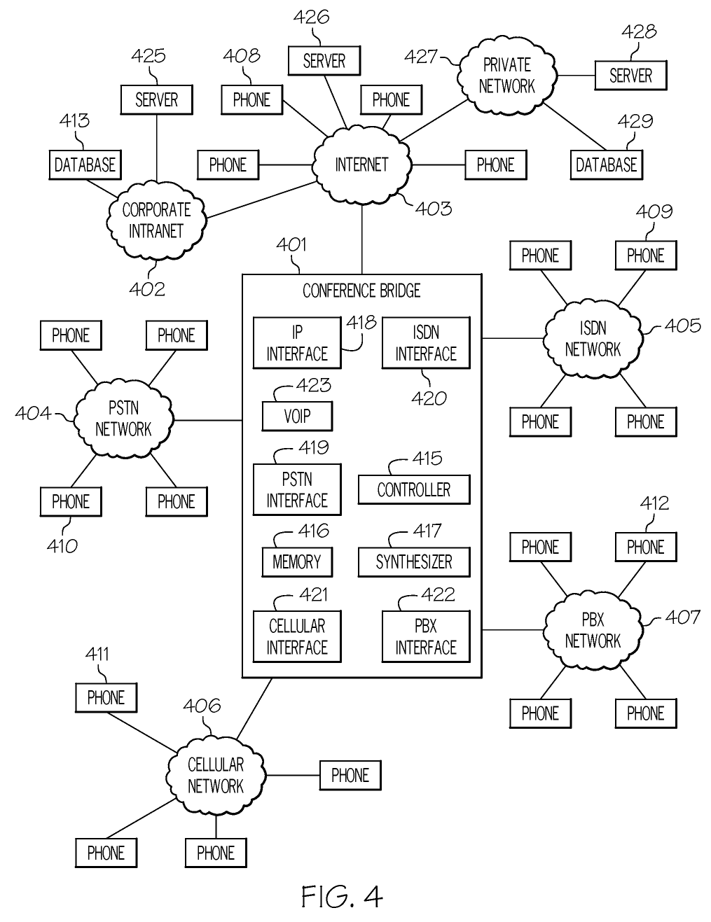

FIG. 4 shows a diagram of a system for accessing information on call invitees according to an exemplary embodiment of the present invention. The system 400 may include a teleconference bridge 401 that may be interconnected to one or more networks or other resources. For example, the conference bridge 401 may be interconnected to the Internet 403 that may be interconnected to one or more telephones 408, a corporate Intranet 402 that may have access to a database 413 and a server 425, a public switched telephone network (PSTN) 404 that may be connected to one or more telephones 410, a cellular network 406 that may be interconnected to one or more telephones 411, a Private Branch Exchange (PBX) network 407 that may be interconnected to one or more telephones 412, an Integrated Services Digital Network (ISDN) 405 that may be interconnected to one or more telephones 409, etc. The Internet 403 may also allow connection to a server 426, and a private network 427 that may be connected to a server 428 and a database 429. The conference bridge 401 may include an Internet Protocol (IP) interface 418, voice over IP (VOIP) processing 423, a PSTN interface 419, an ISDN interface 420, a cellular interface 421, a PBX interface 422, a synthesizer 417, memory 416, and a controller or processor 415 that controls processing and all of the interfaces.

The conference bridge 401 may setup a teleconference call with one or more telephones from any of the networks 402-407. Further, the teleconference bridge 401 may initiate a teleconference call between telephones, receive an inquiry before or during the teleconference call regarding additional information on at least one person invited to join the call, obtain the additional information on each of the at least one person, and send the additional information to the requester either before or during the teleconference call. The conference bridge may also receive a request before or during the teleconference call for any type of data or information not related to an invitee to the teleconference call.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for accessing information on call invitees comprising:
initiating a teleconference call;
receiving an inquiry during the teleconference call regarding additional information on at least one person invited to join the call;
obtaining the additional information on each of the at least one person; and
sending the additional information.

2. The method according to claim 1, further comprising receiving the inquiry from one of a person that has not joined the teleconference call and a person that has joined the teleconference call.

3. The method according to claim 1, further comprising receiving an inquiry requesting a list of all persons invited to join the teleconference call.

4. The method according to claim 1, further comprising the inquiry comprising a key sequence, the key sequence defining a type of inquiry.

5. The method according to claim 1, further comprising receiving an inquiry requesting a list of all persons that have already joined the teleconference call.

6. The method according to claim 1, further comprising receiving an inquiry requesting a list of all persons that have not yet joined the teleconference call.

7. The method according to claim 1, further comprising receiving a request to join the teleconference call from a user, placing the user in a holding state, and receiving an inquiry from the user regarding additional information on at least one person invited to join the call while the user is in the holding state.

8. The method according to claim 1, further comprising receiving a request to join the teleconference call from a user, placing the user in the teleconference call, and receiving an inquiry from the user regarding additional information on at least one person invited to join the call after the user has been placed in the teleconference call.

9. The method according to claim 1, further comprising sending the additional information by one of voice, instant messaging (IM), short message service (SMS) and email.

10. The method according to claim 1, further comprising the additional information comprising at least one of a job title of a person, a department of a person, a phone number of a person, an email of a person, whether a person was invited to the teleconference, whether a person has joined the teleconference

11. The method according to claim 1, further comprising at least one of accessing and updating at least one of a remote network, a database, a meeting invitation, a calendar of a person, a server, and a corporate directory to obtain the additional information on each of the at least one person.

12. A processing device comprising:
a network interface;
at least one second interface, the at least one second interface configured to establish a connection between at least three telephones; and
a controller, the controller being configured to initiate a teleconference call between the at least three telephones, receive an inquiry during the teleconference call regarding additional information on at least one person invited to join the call, obtain the additional information on each of the at least one person, and send the additional information.

13. The device according to claim 12, wherein the device comprises a conference bridge.

14. The device according to claim 12, wherein the at least one second interface comprises at least one of a private branch exchange (PBX) interface, a public switched telephone network (PSTN) interface, a wireless telephone network interface, and an integrated services digital network (ISDN) interface.

15. The device according to claim 12, wherein the network interface is configured to provided access to at least one of a corporate network, the Internet, and a private network.

16. A computer program product comprising a computer useable medium having computer useable program code embodied therewith, the computer useable program code comprising:
computer useable program code configured to initiate a teleconference call;
computer useable program code configured to receive an inquiry during the teleconference call regarding additional information on at least one person invited to join the call;
computer useable program code configured to obtain the additional information on each of the at least one person; and
computer useable program code configured to send the additional information.

17. The computer program product according to claim 16, further comprising computer useable program code configured to receive an inquiry requesting a list of all persons invited to join the teleconference call, computer useable program code configured to receive an inquiry requesting a list of all persons that have already joined the teleconference call, and computer useable program code configured to receive an inquiry requesting a list of all persons that have not yet joined the teleconference call.

18. The computer program product according to claim 16, further comprising computer useable program code configured to receive a request to join the teleconference call from a user, place the user in a holding state, and receive an inquiry from the user regarding additional information on at least one person invited to join the call while the user is in the holding state.

19. The computer program product according to claim 16, further comprising computer useable program code configured to send the additional information by one of voice, instant messaging (IM), short message service (SMS) and email.

20. The computer program product according to claim 16, further comprising computer useable program code configured to at least one of access and update at least one of a remote network, a database, a meeting invitation, a calendar of a person, a server, and a corporate directory to obtain the additional information on each of the at least one person.
